(19) United States
(12) Patent Application Publication
(10) Pub. No.: US 2002/0174603 A1
(43) Pub. Date: Nov. 28, 2002

(54) Method for generating hydrogen for fuel cells

(76) Inventors: Shabbir Ahmed, Naperville, IL (US); Michael Krumpelt, Naperville, IL (US)

Correspondence Address: Mark A. Kassel, FOLEY & LARDNER, 150 East Gilman Street, P.O. Box 1497, Madison, WI, 53701-1497, US

(21) Appl. No.: 09/816,694

(22) Filed: Mar. 23, 2001

(51) Int. Cl. C01B 3/26

(52) U.S. Cl. 48/197 R; 48/127.9; 48/198.5; 48/198.7; 48/203; 48/197 FM; 423/650; 423/651; 423/652

(57) ABSTRACT

A method of generating a H₂ rich gas from a fuel includes supplying a mixture of molecular oxygen, fuel, and water to a fuel processor, and converting the mixture of molecular oxygen, fuel, and water in the fuel processor to the H₂ rich gas. The fuel has the formula CₙHₘOₚ where n has a value ranging from 1 to 20 and is the average number of carbon atoms per mole of the fuel; m has a value ranging from 2 to 42 and is the average number of hydrogen atoms per mole of the fuel; and p has a value ranging from 0 to 12 and is the average number of oxygen atoms per mole of the fuel. The molar ratio of molecular oxygen supplied to the fuel processor per mole of fuel is a value ranging from about 0.5x₀ to about 1.5x₀, and the value of x₀ is equal to 0.312n−0.5p+0.5(ΔH_{f, fuel}/ΔH_{f, water}) where n and p have the values described above, ΔH_{f, fuel} is the heat of formation of the fuel, and ΔH_{f, water} is the heat of formation of water.

The United States government has rights in this invention pursuant to Contract No. W-31-108-ENG-38 between the United States Department of Energy and the University of Chicago representing Argonne National Laboratory.

### FIELD OF THE INVENTION

This invention pertains generally to the field of hydrogen generation. More specifically, the invention relates to a method for autothermally reforming hydrocarbons to produce hydrogen for fuel cell power generating systems.

### BACKGROUND OF THE INVENTION

Fuel cells electrochemically oxidize hydrogen to generate electric power. Without a hydrogen refueling infrastructure, hydrogen has to be produced from available fuels at the point of use. In remote, distributed, and portable power applications, such fuel cell systems require small, lightweight fuel processors that are designed for frequent start ups and are capable of operating at varying loads.

Two processes are industrially used to generate hydrogen from hydrocarbon fuels. These two processes include the steam reforming process and the partial oxidation reforming process. The steam reforming hydrogen production process is the more commonly used process used to produce hydrogen. This is especially true in the chemical industry. Steam reforming is an endothermic reaction that is typically slow to start up. In steam reforming processes, steam reacts with a hydrocarbon fuel in the presence of a catalyst to produce hydrogen. In steam reforming, the process equipment tends to be heavy and is designed for continuous operation under steady state conditions making such systems unsuitable for applications with frequent load variations such as those for use in transportation applications. Additionally, because of the endothermic nature of the process, steam reforming reactors are heat transfer limited. These attributes of steam reforming processes makes them unsuitable for use in remote, distributed, and portable power applications such as for use in a motor vehicles.

Partial oxidation reforming processes are based on exothermic reactions in which some fuel is directly combusted. In partial oxidation reforming, oxygen reacts with a hydrocarbon fuel in the presence of a catalyst to produce hydrogen. Heat transfer limitations are eliminated in partial oxidation reforming processes due to the exothermic nature of the reaction. Additionally, partial oxidation reforming hydrogen production processes and the equipment used in such processes generally allows for faster start ups compared to steam reforming processes. However, reactors used in partial oxidation reforming processes generally operate at temperatures of from about 1100° C. to about 1200° C. to prevent coking in the reactor. One disadvantage associated with partial oxidation reforming is that reactor materials capable of operating at the high temperatures of partial oxidation processes must be used. Suitable materials for use in partial oxidation reforming reactors include ceramics. Ceramic reforming reactors are both expensive and difficult to fabricate.

U.S. Pat. No. 5,248,566 issued to Kumar et al. discloses a fuel cell system for use in transportation applications. In the disclosed fuel cell, a partial oxidation reformer is connected to a fuel tank and to a fuel cell. The partial oxidation reformer produces hydrogen-containing gas by partially oxidizing and reforming the fuel with water and air in the presence of an oxidizing catalyst and a reforming catalyst.

U.S. Pat. No. 6,025,403 issued to Marler et al. discloses a process for integrating an autothermal reforming unit and a cogeneration power plant in which the reforming unit has two communicating fluid beds. The first fluid bed is a reformer reactor containing inorganic metal oxide and which is used to react oxygen and light hydrocarbons at conditions sufficient to produce a mixture of synthesis gas, hydrogen, carbon monoxide, and carbon dioxide. The second fluid bed is a combustor-regenerator which receives spent inorganic metal oxide from the first fluid bed and which provides heat to the inorganic metal and balance the reaction endotherm, by combusting fuel gas in direct contact with the inorganic metal oxide producing hot flue gas. In preferred embodiments, steam is also fed to the reformer reactor and a catalyst may be used with the inorganic metal oxide.

U.S. Pat. No. 6,126,908 issued to Clawson et al. discloses an apparatus and method for converting hydrocarbon fuel or an alcohol into hydrogen gas and carbon dioxide. The apparatus includes a first vessel having a partial oxidation reaction zone and a separate steam reforming reaction zone that is distinct from the partial oxidation reaction zone. The first vessel of the apparatus has a first vessel inlet at the partial oxidation reaction zone and a first vessel outlet at the steam reforming zone. The reformer also includes a helical tube that has a first end connected to an oxygen-containing source and a second end connected to the first vessel at the partial oxidation reaction zone. Oxygen gas from an oxygen-containing source can be directed through the helical tube to the first vessel. The apparatus includes a second vessel with both an inlet and outlet. The second vessel is annularly disposed about the first vessel, and the helical tube is disposed between the first vessel and the second vessel and gases from the first vessel can be directed through the second vessel.

A need remains for a method of optimizing the production of hydrogen in autothermal reforming processes.

### SUMMARY OF THE INVENTION

The invention provides a method for generating a H₂ rich gas stream. The method includes supplying a mixture of molecular oxygen (O₂), fuel, and water to a fuel processor, and converting the mixture of molecular oxygen, fuel, and water in the fuel processor to the H₂ rich gas. The fuel has the formula CₙHₘOₚ where n has a value ranging from 1 to 20 and is the average number of carbon atoms per molecule of the fuel, m has a value ranging from 2 to 42 and is the average number of hydrogen atoms per molecule of the fuel, and p has a value ranging from 0 to 12 and is the average number of oxygen atoms per molecule of the fuel. The molar ratio of molecular oxygen supplied to the fuel processor per mole of fuel is a value ranging from about 0.5x₀ to about 1.5x₀, and the value of x₀ is equal to 0.312n−0.5p+0.5(ΔH_{f, fuel}/ΔH_{f, water}) where n and p have the values described above, ΔH_{f, fuel} is the heat of formation of the fuel, and ΔH_{f, water} is the heat of formation of water. The invention further provides a method of generating a H₂ rich gas stream in which converting the mixture of molecular oxygen, fuel, and water in the fuel processor to produce the H₂ rich gas further includes contacting the mixture of molecular oxygen, fuel, and water with a catalyst in the fuel processor to produce the H₂ rich gas.

The invention also provides methods of generating a H₂ rich gas where the molar ratio of molecular oxygen supplied to the fuel processor per mole of fuel (x) is a value ranging from about x₀ to about 1.5x₀; is a value ranging from 0.8x₀ to about 1.4x₀; is a value ranging from about 0.9x₀ to about 1.3x₀; or is a value ranging from about 0.95x₀ to about 1.2x₀.

The invention further provides methods of generating a H₂ rich gas where the molar ratio of water supplied to the fuel processor per mole of fuel is a value ranging from about 0.8(2n-2x-p) to about 2.0(2n-2x-p). In still other methods the molar ratio of water supplied to the fuel processor per mole of fuel is a value ranging from about 0.9(2n-2x-p) to about 1.5(2n-2x-p); is a value ranging from 0.95(2n-2x₀-p) to about 1.2(2n-2x₀-p); or is a value ranging from about 1.0(2n-2x-p) to about 1.1(2n-2x-p).

The invention further provides method of generating a H₂ rich gas where the molecular oxygen is supplied to the fuel processor in a mixture of gases comprising N₂ and molecular oxygen. In more preferred methods, the mixture of gases comprising N₂ and molecular oxygen is air.

Various fuels may be used in the method of the present invention. In some methods according to the invention, the fuel is selected from methane, methanol, ethane, ethylene, ethanol, propane, propene, i-propanol, n-propanol, butane, butene, butanol, pentane, pentene, hexane cyclohexane, cyclopentane, benzene, toluene, xylene, natural gas, liquefied petroleum gas, iso-octane, gasoline, kerosene, or diesel. In yet other methods, the fuel is selected from methane, natural gas, propane, methanol, ethanol, liquefied petroleum gas, gasoline, kerosene, or diesel.

In other methods according to the invention, the fuel processor includes a reforming portion and the H₂ rich gas exiting the reforming portion is maintained at a temperature of from 100° C. to about 900° C. in the fuel processor. More preferably, the temperature is maintained at from about 400° C. to about 700° C.

In still other methods, the catalyst includes a two part catalyst that includes a transition metal and an oxide-ion conducting portion, and the mixture of molecular oxygen, fuel, and steam is contacted with the catalyst at a temperature of 400° C. or greater. In still other such methods, the transition metal of the catalyst is selected from platinum, palladium, ruthenium, rhodium, iridium, iron, cobalt, nickel, copper, silver, gold, or mixtures of these, and the oxide-ion conducting portion of the catalyst is selected from a ceramic oxide from the group crystallizing in the fluorite structure or LaGaO₃ or mixtures of these.

Further methods are provided in which the catalyst is selected from autothermally reforming catalysts that operate at a temperature ranging from about 100° C. to about 700° C.

Still further methods are provided in which the H₂ rich gas includes carbon monoxide and carbon dioxide, and the method includes contacting the H₂ rich gas with a second catalyst effective at converting carbon monoxide and water into carbon dioxide and H₂ to produce a second gas further enriched in H₂ and with a reduced level of carbon monoxide.

Further features, and advantages of the present invention will be apparent from the following detailed description taken in conjunction with the appended drawings.

### BRIEF DESCRIPTION OF THE DRAWING

The preferred exemplary embodiment of the invention will hereinafter be described in conjunction with the appended drawings.

FIG. 1 is a graph of the heat of reaction (kJ/gmol) versus the molar ratio of O₂ to CH₄ (x) showing the thermoneutral point (x₀) for the autothermal reforming of CH₄ where the feed consists of CH₄, air, and liquid water at 25° C.

FIG. 2 is a graph of the efficiency versus the molar ratio of O₂ to CH₄ (x) for the reaction of CH₄, O₂ and liquid water to form a hydrogen rich gas stream.

FIG. 3 is a graph showing the percentage of carbon monoxide contained in a product stream after emerging from a water-gas-shift reactor loaded with a catalyst (0.8 wt. % platinum on gadolinium doped ceria (Pt/Ce_{0.8}Gd_{0.2}O_{1.95}) as a function of reaction temperature.

### DETAILED DESCRIPTION OF THE INVENTION

Hydrogen used in fuel cells is typically generated from available fuels (CₙHₘOₚ) by means of a reforming reaction. Three processes used to generate hydrogen include steam reforming, partial oxidation, and autothermal reforming. Steam reforming is probably the most commonly used method for producing hydrogen in the chemical process industry. In steam reforming, a fuel reacts with steam in the presence of an appropriate catalyst to provide various carbon oxides and hydrogen. The steam reforming reaction is endothermic and as such exhibits a heat of reaction (ΔHᵣ) greater than 0. In the steam reforming process, various carbon oxides including carbon monoxide and carbon dioxide are formed as byproducts along with the desired hydrogen. The carbon monoxide and carbon dioxide produced in the steam reforming reaction are removed from the reformate gas stream by a variety of reactions and scrubbing techniques, including, but not limited to, the water-gas-shift reaction in which carbon monoxide reacts with water to form carbon dioxide and hydrogen; methanation; carbon dioxide absorption in amine solutions; and pressure swing adsorption. The steam reforming reaction is strongly endothermic and reactor designs are thus typically limited by heat transfer considerations, rather than reaction kinetics. Consequently, reactors for use in steam reforming are designed to promote heat exchange and tend to be large and heavy.

Partial oxidation reformers react the fuel with a stoichiometric amount of O₂. The initial oxidation reaction results in heat generation and high temperatures as the reaction is strongly exothermic and thus has a heat of reaction (ΔHᵣ) of less than 0. In the partial oxidation reaction, fuel reacts with oxygen typically a component of air to produce hydrogen and carbon oxides including carbon monoxide and carbon dioxide. The heat generated by the oxidation reaction raises the gas temperature to over 1,000° C. In fact, partial oxidation reactors are typically operated at temperatures of from 1,100° C. to 1200° C. because the gas phase oxidation of hydrocarbons requires these temperatures in order to prevent coking in the reactor.

The invented process overcomes the high temperature problem of partial oxidation reactors, yet has excellent transient response capability, a significant problem associated with steam reforming.

The method of the present invention uses a mixture of molecular oxygen and steam or water to convert fuels to a hydrogen rich gas. Typically, and preferably the oxygen is a component of air so that the process uses air and water or steam, to convert the fuel to a hydrogen rich gas. In the method of the present invention, the molar ratios of air to fuel and water to fuel are controlled to provide optimal conditions for autothermally reforming the fuel into the hydrogen rich gas.

The chemical reaction used to represent the autothermal reforming of a fuel can be written as follows assuming the complete conversion of the fuel to carbon dioxide and hydrogen:

CₙHₘOₚ+x(O₂+yN₂)+(2n-2x-p)H₂O→nCO₂+(2n-2x-p+m/2)H₂+xyN₂

where:

CₙHₘOₚ is the fuel;

n is the number of carbon atoms per molecule of the fuel and the number of moles of carbon oxides formed per mole of the fuel;

m is the number of hydrogen atoms per molecule of the fuel;

p is the number of oxygen atoms per molecule of the fuel;

x is the molar ratio of molecular oxygen (O₂) per mole of the fuel;

y is the number of moles of N₂ per mole of the molecular oxygen that is supplied per mole of the fuel;

(2n-2x-p) is the molar ratio of water per mole of the fuel;

(2n-2x-p+m/2) is the number of moles of hydrogen produced per mole of the fuel; and

xy is the number of moles of N₂ in the system per mole of the fuel.

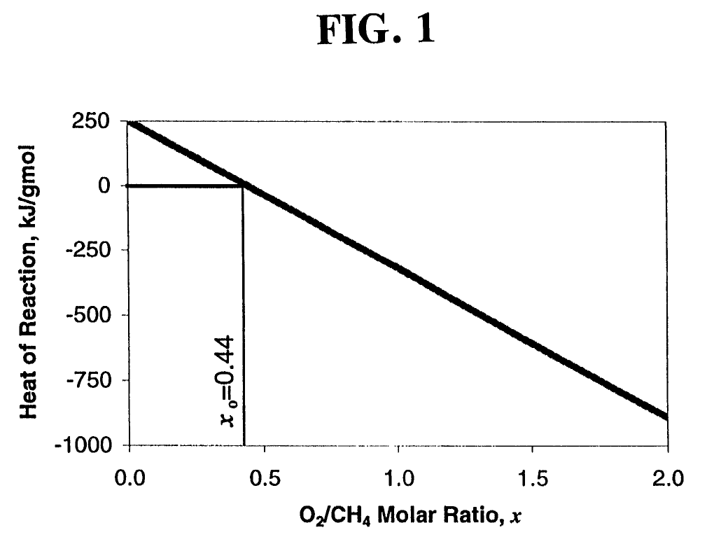

If the oxygen to fuel ratio is defined as x, then the water to fuel molar ratio required to convert the carbon to carbon dioxide must be equal to 2n-2x-p. The reaction will be endothermic at low values of x as the amount of oxygen will be insufficient to decrease the heat of reaction below 0. At high values of x, the reaction is exothermic as the amount of oxygen present in the reaction is sufficient to decrease the heat of reaction below 0. At an intermediate value of x (x₀, the thermoneutral point) the heat of reaction is zero. FIG. 1 is a graph of the heat of reaction versus the molar ratio of O₂ to CH₄ (x) for the autothermal reforming of methane using liquid water. As shown in FIG. 1, x₀ has the value of 0.44 for the autothermal reforming of methane using liquid water. At x₀, the heat of reaction is zero. When the molar ratio of oxygen to fuel increases beyond x₀, the reaction becomes exothermic as indicated by the negative heats of reactions. On the other hand, when the molar ratio of oxygen to fuel (x) drops below the value of x₀, the reaction becomes endothermic as indicated by the positive values for the heat of reaction.

Generally, the reforming process should be conducted at or close to the thermoneutral point (x₀). This means that the molar ratio of molecular oxygen to fuel supplied to the fuel processor should be as close to x₀ as possible since this represents the condition where the process has been found to be most efficient. However, the molar ratio of molecular oxygen to fuel may vary depending on the choice of catalyst. In certain preferred methods according to the present invention, the molar ratio of molecular oxygen supplied to the fuel processor per mole of fuel (x) is a value ranging from about x₀ to about 1.5x₀ and in still other more preferred embodiments, the value ranges from about 0.5x₀ to about 1.5x₀. In other preferred processes, the molar ratio of molecular oxygen supplied to the fuel processor per mole of fuel is a value ranging from about 0.8x₀ to about 1.4x₀; from about 0.9x₀ to about 1.3x₀; or from about 0.95x₀ to about 1.2x₀.

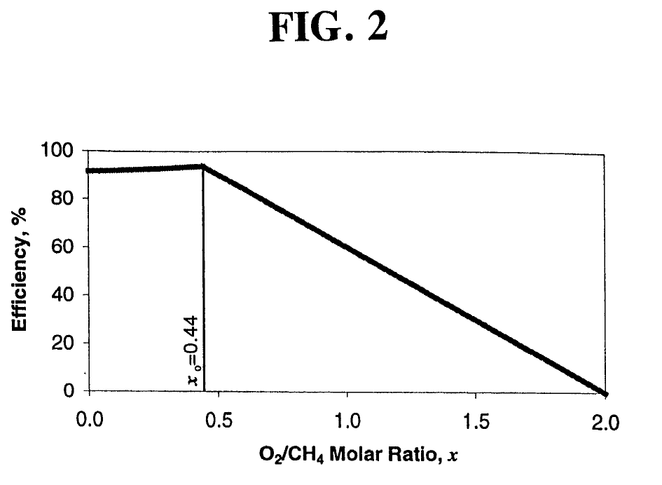

FIG. 2 is a graph showing the energy efficiency as a function of the molar ratio of CH₄ to molecular oxygen for the generation of hydrogen from methane and water. As shown in FIG. 2, the autothermal conversion of methane and water to hydrogen is most efficient when the reaction is conducted with a molar ratio of molecular oxygen to fuel near the thermoneutral x₀ value. As shown in FIG. 2, the efficiency of the process remains quite high when the molar ratio of O₂ to CH₄ is less than x₀, but the efficiency drops off rapidly when the molar ratio of O₂ to CH₄ increases over x₀. For the purposes of this discussion, efficiency is defined as the lower heating value of the product hydrogen, as a percentage of the lower heating value of the fuel feed. Although the process is most efficient when the molar ratio of O₂ to the fuel is x₀, to achieve fast enough reaction rates and to obtain high hydrogen concentrations in the product gas, it is preferable to operate the reactor at a temperature of from about 100° C. to about 900° C. In another preferred process, the reactor is maintained at a temperature of from about 400° C. to about 700° C. In still other preferred processes, the reactor is maintained at a temperature of about 700° C. Preferred fuel processors for use in the method of the present invention include a reforming portion in which the mixture of oxygen, fuel, and water are converted to a H₂ rich gas stream. In preferred processes according to the present invention, the H₂ rich gas exits the reforming portion at a temperature of from at or about 100° C. to at or about 900° C. and more preferably from at or about 400° C. to at or about 700° C. The preferred operating temperatures are achieved by increasing the air to fuel ratio slightly above the thermoneutral point.

As noted above, when the molar ratio of O₂ to fuel is greater than x₀, the reaction is exothermic such that the desired temperature may be achieved. The lower operating temperatures of the fuel processor that are obtained using the method of the present invention result in less carbon monoxide being produced in the reforming portion of the fuel processor. Thus, converting the mixture of oxygen, fuel, and water under the conditions described herein less carbon monoxide is produced and consequently, less carbon monoxide needs to be water-gas-shifted to produce carbon dioxide and H₂. This is one significant advantages offered when the method of the present invention is used. Table 1 shows experimental examples for the conversion of various fuels at specified O₂ to fuel molar ratios (x); water to fuel molar ratios (2n-2x-p) [the water/fuel molar ratios in Table 1 are greater than 2n-2x-p]; and reactor temperatures. Table 1 also provides data regarding the composition of the hydrogen rich gas produced by the process as percentages on a dry nitrogen-free basis.

TABLE 1
Percentages of hydrogen, carbon monoxide, and carbon dioxide
obtained from the autothermal reforming of hydrocarbon fuels.

| | | | | Composition (%) | | |
|---|---|---|---|---|---|---|
| Hydrocarbon | | | Temp | Dry, N₂-free basis | | |
| (CₙHₘOₚ) | O₂/CₙHₘOₚ | H₂O/CₙHₘOₚ | (° C.) | H₂ | CO | CO₂ |
| Iso-Octane | 3.7 | 9.1 | 630 | 60 | 16 | 20 |
| Cyclohexane | 2.8 | 8.2 | 700 | 59 | 16 | 24 |
| 2-Pentene | 2.3 | 6.0 | 670 | 60 | 18 | 22 |
| Ethanol | 0.46 | 2.4 | 580 | 62 | 15 | 18 |
| Methanol | 0.3 | 0.53 | 450 | 60 | 18 | 20 |
| Methane | 0.5 | 1.8 | 690 | 70 | 14 | 16 |

The molar ratio of water to fuel (2n-2x-p) has also been found to effect the efficiency of hydrogen production. Preferably, the molar ratio of water to fuel supplied to the fuel processor is a value ranging from about 0.8(2n-2x-p) to about 2(2n-2x-p). In other preferred methods of generating a hydrogen rich gas from a fuel, the molar ratio of water to fuel ranges from about 0.9(2n-2x-p) to about 1.5(2n-2x-p); from about 0.95(2n-2x-p) to about 1.2(2n-2x-p); or from about 1.0(2n-2x-p) to about 1.1(2n-2x-p). In most preferred methods according to the present invention, the molar ratio of molecular oxygen supplied to the fuel processor per mole of fuel (x) is a value ranging from about 0.95x₀ to about 1.2x₀ and the molar ratio of water supplied to the fuel processor per mole of fuel is a value ranging from about 1.0(2n-2x-p) to about 1.1(2n-2x-p). Because the values of x₀ and (2n-2x-p) are relatively simple to ascertain, preferred methods according to the present invention are those in which these values are predetermined prior to converting the mixture of oxygen, fuel and water to the H₂ rich gas stream. Based on catalyst selection and other considerations, preferred methods include choosing values of x₀ and or (2n-2x-p) prior to or during the production of H₂ process.

As noted above, the invention provides a method for generating hydrogen rich gas and includes supplying a mixture of O₂, fuel, and water to a fuel processor and converting the mixture to the hydrogen rich gas stream. A fuel processor such as those disclosed in the United States Patent Application entitled “Fuel Processor and Method for Generating Hydrogen for Fuel Cells”, the entire disclosure of which is hereby incorporated by reference, by the inventors S. Ahmed, S. H. W. Lee, J. D. Carter, and M. Krumpelt and filed simultaneously with the present invention, may be used in conjunction with the present invention. Preferably, the conversion of the mixture of molecular oxygen, fuel, and water to the H₂ rich gas stream includes contacting the mixture with a catalyst in the fuel processor to produce the H₂ rich gas stream. As described above, the molar ratio of O₂ to fuel and the molar ratio of water to fuel are both dependent on the determination of the value of x₀ for a particular fuel. The value of x₀ for a particular fuel of formula CₙHₘOₚ may be determined using the equation 0.312n−0.5p+0.5(ΔH_{f, fuel}/ΔH_{f, water}) where ΔH_{f, fuel} is the heat of formation of the fuel and ΔH_{f, water} is the heat of formation of water.

Generally, the invention provides a method of generating a hydrogen (H₂) rich gas from a fuel. The method includes supplying a mixture of molecular oxygen (O₂), fuel, and water to a fuel processor and converting the mixture of molecular oxygen, fuel, and water in the fuel processor to the hydrogen rich gas. Preferably, the mixture of oxygen, fuel, and water is contacted with a catalyst in the fuel processor to produce the H₂ rich gas. The fuel has the formula CₙHₘOₚ where n has a value ranging from 1 to 20 and represents the average number of carbon atoms per molecule of the fuel, m has a value ranging from 2 to 42 and represents the average number of hydrogen atoms per molecule of the fuel, and p has a value ranging from 0 to 12 and represents the average number of oxygen atoms per molecule of the fuel. The molar ratio of molecular oxygen supplied to the fuel processor per mole of fuel is a value ranging from about 0.5x₀ to about 1.5x₀, and the value of x₀ is equal to 0.312n −0.5p+0.5(ΔH_{f, fuel}/ΔH_{f, water}) where n and p have the values described above, ΔH_{f, fuel} is the heat of formation of the fuel, and ΔH_{f, water} is the heat of formation of water.

As noted above, the thermoneutral point (x₀) may be readily calculated for any fuel using the following equation as long as the values of n, p, and heat of formation of the fuel is known:

x₀=0.312n−0.5p+0.5(ΔHf, fuel/ΔHf, water)

where:

n is the number of carbon atoms in the fuel molecule;

p is the number of oxygen atoms in the fuel molecule;

ΔH_{f, fuel} is the heat of formation of the fuel at 298K; and

ΔH_{f, water} is the heat of formation of water at 298K which has a value of−68,317 cal/gmol or −68.317 kcal/gmol when the feed consists of water in the liquid phase, and has a value of −57,798 cal/gmol or −57.798 kcal/gmol when the feed consists of water in the vapor phase.

Using the above equation, the value of x₀ may be calculated for a fuel such as methane (CH₄) for which n=1, m=4, and p=0. Methane has a heat of formation of −17.9 kcal/gmol so x₀=0.312(1)−0.5(0)+0.5(−17.9/−68.3) with the units not shown for the heats of formation for the fuel and the water since they cancel each other out. Thus, according to the equation x₀=0.312+0.5(0.262) or a value of 0.443 for methane, where water in the feed is in the liquid phase.

Table 2 provides x₀ values for a number of fuels based upon the calculation method described above.

TABLE 2
Calculated thermoneutral O₂/fuel ratios (X₀) and maximum
theoretical efficiencies at xo for various fuels.

| Fuel | | | | ΔH_{f} | | | Efficiency |
|---|---|---|---|---|---|---|---|
| CₙHₘOₚ | n | m | p | (kcal/gmol) | m/2n | X₀ | (%) |
| Methanol | 1 | 4 | 1 | −57.1 | 2 | 0.230 | 96.3 |
| CH₃OH | | | | | | | |
| Methane | 1 | 4 | 0 | −17.9 | 2 | 0.443 | 93.9 |
| CH₄ | | | | | | | |
| Acetic Acid | 2 | 4 | 2 | −116.4 | 1 | 0.475 | 94.1 |
| C₂H₄O₂ | | | | | | | |
| Ethane | 2 | 6 | 0 | −20.2 | 1.5 | 0.771 | 92.4 |
| C₂H₆ | | | | | | | |
| Ethylene | 2 | 6 | 2 | −108.6 | 1.5 | 0.418 | 95.2 |
| Glycol | | | | | | | |
| C₂H₆O₂ | | | | | | | |
| Ethanol | 2 | 6 | 1 | −66.2 | 1.5 | 0.608 | 93.7 |
| C₂H₆O | | | | | | | |
| Pentene | 5 | 10 | 0 | −5.0 | 1 | 1.595 | 90.5 |
| C₅H₁₂ | | | | | | | |
| Pentane | 5 | 12 | 0 | −35.0 | 1.2 | 1.814 | 91.5 |
| C₅H₁₂ | | | | | | | |
| Cyclohexane | 6 | 12 | 0 | −37.3 | 1 | 2.143 | 90.7 |
| C₆H₁₂ | | | | | | | |
| Benzene | 6 | 6 | 0 | 11.7 | 0.5 | 1.784 | 88.2 |
| C₆H₆ | | | | | | | |
| Toluene | 7 | 8 | 0 | 2.9 | 0.571 | 2.161 | 88.6 |
| C₇H₈ | | | | | | | |
| Iso-Octane | 8 | 18 | 0 | −62.0 | 1.125 | 2.947 | 91.2 |
| C₈H₁₈ | | | | | | | |
| Gasoline | 7.3 | 14.8 | 0.1 | −53.0 | 1.014 | 2.613 | 90.8 |
| C_{7.3}H_{14.8}O_{0.1} | | | | | | | |

The heats of formation for numerous organic compounds and fuels are readily known and can be obtained from such sources as the CRC Handbook of Chemistry and Physics. The method can be used to calculate the thermoneutral point (x₀) for pure fuels such as methane as described above. It can also be used to calculate the thermoneutral point for a fuel that comprises a mixture of materials such as gasoline where n is the average number of carbon atoms per mole of the fuel mixture, m is the average number of hydrogen atoms per mole of the fuel mixture, and p is the average number of oxygen atoms per mole of the fuel mixture. Thus, the above-described method for calculating the x₀ value may be used for any pure fuel or mixture of fuels as long as the heat of formation of the fuel is known and the values for n, m, and p are ascertained which is simply accomplished in the case of pure fuels.

Various fuels may be used in the method of the present invention. Fuels are generally represented by the formula CₙHₘOₚ where n represents the number of carbon atoms in the molecular formula of the fuel, m represents the number of hydrogen atoms in the molecular formula of the fuel, and p represents the number of oxygen atoms, if any, in the fuel. In preferred fuels according to the present invention, n has a value ranging from 1 to 20, m has a value ranging from 2 to 42, and p has a value ranging from 0 to 12. Preferred fuels for use in the method of the present invention include straight and branched chain alkanes, alkenes, alkynes, alkanols, alkenols, and alkynols; cycloalkanes; cycloalkenes; cycloalkanols; cycloalkenols; aromatic compounds including, but not limited to toluene, xylene, and benzene; ketones, aldehydes, carboxylic acids, esters, ethers, sugars, and generally other organic compounds containing carbon, hydrogen, and optionally oxygen. One preferred group of fuels includes alkanes such as methane, ethane, and the various isomers of propane, butane, pentane, hexane, heptane, and octane. Alkenes corresponding to the listed alkanes are also preferred for use in the present invention. Alcohols are another preferred fuel for use in the present invention. Preferred alcohols include methanol, ethanol, ethylene glycol, propylene glycol, and the various isomers of propanol, butanol, pentanol, hexanol, heptanol, and octanol. Other preferred fuels include cyclohexane and cyclopentane. One preferred group of fuels include methane, methanol, ethane, ethanol, acetic acid, ethylene glycol, pentene, pentane, cyclohexane, benzene, toluene, iso-octane, and gasoline.

Fuels for use in the present invention may also include mixtures such as natural gas which primarily comprises methane, and gasoline and diesel which both include a mixture of various compounds. One preferred group of fuels for use in the present invention includes methane, methanol, ethane, ethylene, ethanol, propane, propene, i-propanol, n-propanol, butane, butene, butanol, pentane, pentene, hexane cyclohexane, cyclopentane, benzene, toluene, xylene, natural gas, liquefied petroleum gas, iso-octane, gasoline, kerosene, and diesel. Other more preferred fuels include methane, natural gas, propane, methanol, ethanol, liquefied petroleum gas, gasoline, kerosene, and diesel. It will be understood that, for the purposes of this discussion, that the value of n for fuels that comprise more than one compound will be the average value based on the percentages of components. The same is true for m and p. Thus, n may be said to represent the average number of carbon atoms per molecule of the fuel, m may be said to represent the average number of hydrogen atoms per molecule of the fuel, and p may be said to represent the average number of oxygen atoms per molecule of the fuel. Thus, for a mixture of hexane and ethanol in which each component is present in an amount of 50 percent based on the number of moles, the formula for determining n is 0.5(6 carbon atoms from hexane)+0.5(2 carbon atoms from ethanol)=4; the formula for determining the value of m is 0.5(14 H atoms from hexane)+0.5(6 H atoms from ethanol)=10; and the formula for determining the value of p is 0.5(0 O atoms from hexane)+0.5(1 O atom from ethanol)=0.5.

Various catalysts may be used in the method of the present invention. Examples of particularly suitable catalysts for use in autothermal reforming are set forth in U.S. Pat. No. 5,929,286, the entire disclosure of which is incorporated herein. Thus, in a preferred method according to the invention, the catalyst includes a transition metal and an oxide-ion conducting portion, and the mixture of molecular oxygen, fuel, and water is contacted with the catalyst at a temperature of 400° C. or greater. Preferably, the transition metal of the catalyst includes a metal selected from platinum, palladium, ruthenium, rhodium, iridium, iron, cobalt, nickel, copper, silver, gold, and mixtures of these and the oxide-ion conducting portion of the catalyst is selected form a ceramic oxide from the group crystallizing in the fluorite structure or LaBaO₃ or mixtures of these. In other preferred methods according to the invention, the catalyst is an autothermally reforming catalyst that operates at a temperature ranging from about 100° C. to about 700° C.

As noted above, the hydrogen rich gas produced by the method of the present invention includes carbon oxides including carbon dioxide and carbon monoxide. In particularly preferred processes according to the invention, the H₂ rich gas which also comprises carbon monoxide and carbon dioxide is contacted with a second catalyst effective at converting carbon monoxide and water into carbon dioxide by the water-gas-shift reaction. In this way a second gas is produced which is further enriched in H₂ and which has a reduced level of carbon monoxide compared to the initial H₂ rich gas produced by the reaction of fuel, water, and oxygen. The water-gas-shift catalyst may include various catalysts including, but not limited to, iron chromium oxide, copper zinc oxide, or platinum on an oxide ion conductor (e.g. gadolinium doped ceria). Alternative formulations for the water-gas-shift catalyst include platinum, palladium, nickel, iridium, rhodium, cobalt, copper, gold, ruthenium, iron, silver, in addition to other transition metals on cerium oxide or oxide-ion conductors such as ceria doped with rare-earth elements including, but not limited to, gadolinium, samarium, yttrium, lanthanum, praseodymium, and mixtures of these. The ceria may also be doped with alkaline earth elements including, but not limited to, magnesium, calcium, strontium, barium, or mixtures of these. Typically, iron chromium oxide catalysts are operated between about 300° C. to 380° C., copper zinc oxide catalysts are operated between 200° C. and 260° C., and platinum catalysts are operated in the range of from about 200° C. to about 450° C.

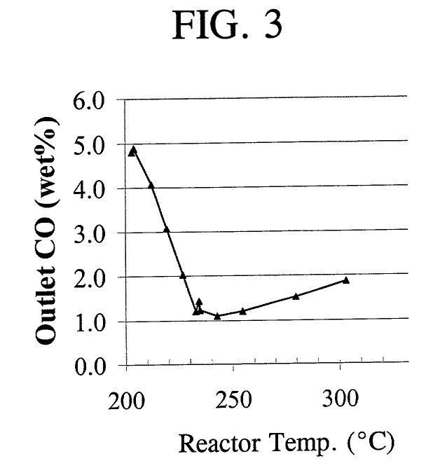

The reaction temperature plays an important role in the amount of carbon monoxide emerging from a water-gas-shift reactor. The method of the present invention can thus be used to modify the temperature of gas streams that will be directed, after reforming, to a water-gas-shift reactor with a particular catalyst. For example, the molar ratio of molecular oxygen to fuel may be adjusted to produce a hotter or cooler stream that matches the preferred temperature range over which the water-gas shift catalyst functions. FIG. 3 is a graph showing the percentage of carbon monoxide contained in a product stream after emerging from a water-gas-shift reactor loaded with a catalyst (0.8 wt. % platinum on gadolinium doped ceria (Pt/Ce_{0.8}Gd_{0.2}O_{1.95}) as a function of reaction temperature. The reactant composition prior to contacting the water-gas-shift reactor on a dry basis was 10.5% CO, 31.2% N₂, 1.9% CH₄, and 43.4% H₂. The H₂O/CO molar ratio in the reactant stream was 3.5. As shown in FIG. 3, for this particular platinum on gadolinium doped ceria catalyst stream, the preferred reaction temperature ranges from about 200° C. to about 300° C. More preferably, the reaction temperature ranges from about 210° C. to about 280° C. and still more preferably ranges from about 225° C. to about 270° C. Most preferably, the reaction temperature using the platinum on gadolinium doped ceria water-gas-shift catalyst ranges from about 225° C. to about 260° C. and is about 240° C.

It is understood that the present invention is not limited to the specific applications and embodiments illustrated and described herein, but embraces such modified forms thereof as come within the scope of the following claims.

What is claimed is:

1. A method of generating a H₂ rich gas from a fuel, comprising: supplying a mixture of molecular oxygen, fuel, and water to a fuel processor; and converting the mixture of molecular oxygen, fuel, and water in the fuel processor to the H₂ rich gas, wherein the fuel has the formula CₙHₘOₚ where n has a value ranging from 1 to 20 and is the average number of carbon atoms per molecule of the fuel, m has a value ranging from 2 to 42 and is the average number of hydrogen atoms per molecule of the fuel, p has a value ranging from 0 to 12 and is the average number of oxygen atoms per molecule of the fuel, and further wherein the molar ratio of molecular oxygen supplied to the fuel processor per mole of fuel is represented by the symbol x and has a value ranging from about 0.5x₀ to about 1.5x₀, wherein x₀ is equal to 0.3 12n−0.5p+0.5(ΔH_{f, fuel}/ΔH_{f, water}) where n and p have the values described above, ΔH_{f, fuel} is the heat of formation of the fuel, and ΔH_{f, water} is the heat of formation of water.

2. The method of claim 1, wherein converting the mixture of molecular oxygen, fuel, and water in the fuel processor to produce the H₂ rich gas further comprises contacting the mixture of molecular oxygen, fuel, and water with a catalyst in the fuel processor to produce the H₂ rich gas.

3. The method of claim 1, wherein the molar ratio of molecular oxygen supplied to the fuel processor per mole of fuel is x and has a value ranging from about x₀ to about 1.5x₀.

4. The method of claim 1, wherein the molar ratio of molecular oxygen supplied to the fuel processor per mole of fuel is x and the molar ratio of water supplied to the fuel processor per mole of fuel is a value ranging from about 0.8(2n-2x-p) to about 2.0(2n-2x-p).

5. The method of claim 4, wherein the molar ratio of water supplied to the fuel processor per mole of fuel is a value ranging from about 0.9(2n-2x-p) to about 1.5(2n-2x-p).

6. The method of claim 5, wherein the molar ratio of water supplied to the fuel processor per mole of fuel is a value ranging from about 0.95(2n-2x-p) to about 1.2(2n-2x-p).

7. The method of claim 6, wherein the molar ratio of water supplied to the fuel processor per mole of fuel is a value ranging from about 1.0(2n-2x-p) to about 1.1(2n-2x-p).

8. The method of claim 1, wherein the molecular oxygen is supplied to the fuel processor in a mixture of gases comprising N₂ and molecular oxygen.

9. The method of claim 1, wherein the mixture of gases comprising N₂ and molecular oxygen is air.

10. The method of claim 1, wherein the fuel is selected from the group consisting of methane, methanol, ethane, ethylene, ethanol, propane, propene, i-propanol, n-propanol, butane, butene, butanol, pentane, pentene, hexane cyclohexane, cyclopentane, benzene, toluene, xylene, natural gas, liquefied petroleum gas, iso-octane, gasoline, kerosene, and diesel.

11. The method of claim 10, wherein the fuel is selected from the group consisting of methane, natural gas, propane, methanol, ethanol, liquefied petroleum gas, gasoline, kerosene, and diesel.

12. The method of claim 1, wherein the fuel processor comprises a reforming portion and the H₂ rich gas exiting the reforming portion is maintained at a temperature of from about 100° C. to about 900° C.

13. The method of claim 1 wherein the fuel processor comprises a reforming portion and the H₂ rich gas exiting the reforming portion is maintained at a temperature of from about 400° C. to about 700° C.

14. The method of claim 1, wherein the molar ratio of molecular oxygen supplied to the fuel processor per mole of fuel is x and has a value ranging from about 0.8x₀ to about 1.4x₀.

15. The method of claim 14, wherein the molar ratio of molecular oxygen supplied to the fuel processor per mole of fuel is x and has a value ranging from about 0.9x₀ to about 1.3x₀.

16. The method of claim 15, wherein the molar ratio of molecular oxygen supplied to the fuel processor per mole of fuel is x and has a value ranging from about 0.95x₀ to about 1.2x₀.

17. The method of claim 16, wherein the molar ratio of molecular oxygen supplied to the fuel processor per mole of fuel is x and the molar ratio of water supplied to the fuel processor per mole of fuel is a value ranging from about 1.0(2n-2x-p) to about 1.1(2n-2x-p).

18. The method of claim 2, wherein the catalyst comprises a two part catalyst comprising a transition metal and an oxide-ion conducting portion, and the mixture of molecular oxygen, fuel, and water is contacted with the catalyst at a temperature of 400° C. or greater.

19. The method of claim 18, wherein the transition metal is selected from the group consisting of platinum, palladium, ruthenium, rhodium, iridium, iron, cobalt, nickel, copper, silver, gold, and mixtures thereof, and the oxide-ion conducting portion of the catalyst is selected from a ceramic oxide from the group crystallizing in the fluorite structure or LaGaO₃ or mixtures thereof.

20. The method of claim 2, wherein the catalyst is selected from the group of autothermally reforming catalysts that operate at a temperature ranging from about 100° C. to about 700° C.

21. The method of claim 2, wherein the H₂ rich gas comprises carbon monoxide and carbon dioxide, and the method further comprises contacting the H₂ rich gas with a second catalyst effective at converting carbon monoxide and water into carbon dioxide and H₂ to produce a second gas further enriched in H₂ and with a reduced level of carbon monoxide.

22. The method of claim 21, wherein the second catalyst comprises a transition metal on cerium oxide or on ceria doped with a rare earth or an alkaline earth element, further wherein the transition metal is selected from the group consisting of platinum, palladium, nickel, iridium, rhodium, cobalt, copper, gold, ruthenium, iron, silver, and combinations thereof, the rare earth element is selected from the group consisting of gadolinium, samarium, yttrium, lanthanum, praseodymium, and combinations thereof, and the alkaline earth element is selected from the group consisting of magnesium, calcium, strontium, barium, and combinations thereof.
